(19) United States
(12) Patent Application Publication
(10) Pub. No.: US 2026/0148890 A1
(43) Pub. Date: May 28, 2026

(54) COIL COMPONENT

(71) Applicant: SAMSUNG ELECTRO-MECHANICS CO., LTD., Suwon-si (KR)

(72) Inventors: Joung Hee CHO, Suwon-si (KR); Dong Hwi AHN, Suwon-si (KR); Kang Ryong CHOI, Suwon-si (KR); Ic Seob KIM, Suwon-si (KR); Soon Kwang KWON, Suwon-si (KR); Dong Gun LEE, Suwon-si (KR)

(73) Assignee: SAMSUNG ELECTRO-MECHANICS CO., LTD., Suwon-si (KR)

(21) Appl. No.: 19/269,663

(22) Filed: Jul. 15, 2025

(30) Foreign Application Priority Data
Nov. 27, 2024 (KR) 10-2024-0172495

(51) Int. Cl. H01F 27/28; H01F 27/02; H01F 27/32

(52) U.S. Cl. CPC H01F 27/2828; H01F 27/022; H01F 27/32

(57) ABSTRACT

A coil component includes a body including a first side surface and a second side surface opposing each other in a first direction, and a third side surface and a fourth side surface opposing each other in a second direction, the body including a magnetic material, a coil disposed in the body, the coil forming at least one turn, and a lead frame connected to both ends of the coil in the body, the lead frame disposed on the first side surface and the second side surface of the body. When a shortest distance between the coil and the third side surface of the body is denoted by My and a length of the body in the second direction is denoted by W, My/W satisfies 0 or more and 0.1 or less.

### CROSS-REFERENCE TO RELATED APPLICATION(S)

This application claims benefit of priority to Korean Patent Application No. 10-2024-0172495 filed on Nov. 27, 2024 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor.

Recently, the market for high-current power inductors used in AI, automotive electronics, and robotics has been growing rapidly. In particular, automotive components may require high-reliability technology to enhance safety, and may also need to have vibration resistance while satisfying high-current characteristics.

In particular, when a body is formed of metallic magnetic powder particles, a coil may be buried in the body. However, a size of an air core may not be increased indefinitely, which may result in a limitation in a design margin of a component.

### SUMMARY

An aspect of the present disclosure is to improve a filling rate of a coil air core by adjusting a design margin of a coil component.

According to an aspect of the present disclosure, there is provided a coil component including a body including a first side surface and a second side surface opposing each other in a first direction, and a third side surface and a fourth side surface opposing each other in a second direction, the body including a magnetic material, a coil disposed in the body, the coil forming at least one turn, and a lead frame connected to both ends of the coil in the body, the lead frame disposed on the first side surface and the second side surface of the body. When a shortest distance between the coil and the third side surface of the body is denoted by My and a length of the body in the second direction is denoted by W, My/W may satisfy 0 or more and 0.1 or less.

According to another aspect of the present disclosure, there is provided a coil component including a body including a first side surface and a second side surface opposing each other in a first direction, and a third side surface and a fourth side surface opposing each other in a second direction, the body including a magnetic material, a coil disposed in the body, the coil forming at least one turn, and a lead frame connected to both ends of the coil in the body, the lead frame disposed on the first side surface and the second side surface of the body. When a shortest distance between the coil and the first side surface of the body is denoted by Mx and a length of the body in the first direction is denoted by L, Mx/L may satisfy 0 or more and 0.1 or less.

According to example embodiments of the present disclosure, a coil component may improve a filling rate of a coil air core by adjusting a design margin of a component.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a coil component according to an example embodiment of the present disclosure;

FIG. 2 is a cross-sectional view of the coil component of FIG. 1, taken along line I-I′;

FIG. 3 is a view of the body (a molded portion and a cover portion) of FIG. 1;

FIG. 4 is a view of a body (a molded portion and a cover portion) of a modification of FIG. 3;

FIG. 5 is a view of a body (a molded portion and a cover portion) of another modification of FIG. 3;

FIG. 6 is a transmission view of a coil component, when viewed in a Z-direction;

FIG. 7 is a modification of FIG. 6;

FIG. 8A is a view of FIG. 7, when viewed in a Y-direction;

FIG. 8B is a is a view of FIG. 7, when viewed in a Y-direction of modification of FIG. 8A;

FIG. 9 is another modification of FIG. 6; and

FIG. 10 is another modification of FIG. 6.

### DETAILED DESCRIPTION

The terms used herein are for the purpose of describing particular example embodiments only, and are not intended to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, operations, operations, elements, components or a combination thereof, but do not preclude the presence or addition of one or more other features, integers, operations, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an X-direction may be defined as a first direction or a length direction, a Y-direction may be defined as a second direction or a width direction, and a Z-direction may be defined as a third direction or a thickness direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

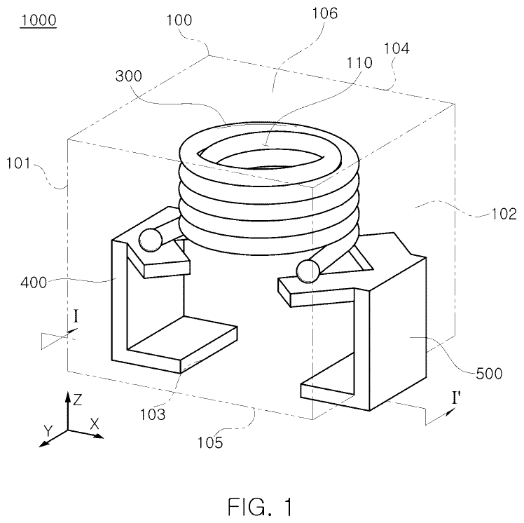

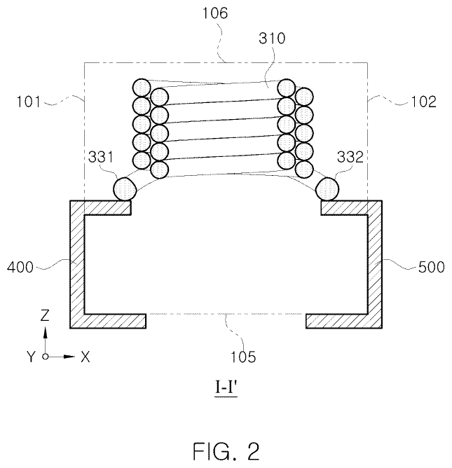

FIG. 1 is a perspective view of a coil component according to an example embodiment of the present disclosure. FIG. 2 is a cross-sectional view of the coil component of FIG. 1, taken along line I-I′.

Referring to FIG. 1, a coil component according to an example embodiment of the present disclosure may include a body 100 including a magnetic material, a coil 300 disposed in the body 100, and lead frames 400 and 500 disposed on a first side surface 101 and a second side surface 102 of the body.

The body 100 may form the overall exterior of the coil component 1000 according to the present example embodiment, and may include the coil 300 buried therein.

The body 100 may have an overall hexahedral shape. Referring to FIG. 1, the body 100 may include a first side surface 101 and a second side surface 102 opposing each other in a first direction (X-direction), a third side surface 103 and a fourth side surface 104 opposing each other in a second direction (Y-direction), and one surface 105 and the other surface 106 opposing each other in a third direction (Z-direction). Each of the first to fourth side surfaces 101, 102, 103, and 104 of the body 100 may correspond to a side surface of the body 100 connecting the one surface 105 and an upper surface 106 of the body 100 to each other.

With respect to an optical microscope or scanning electron microscope (SEM) image of a cross-section in a length direction X and a thickness direction Z obtained by cutting a central portion of the coil component 1000 in a width direction Y, a length of the coil component 1000 may refer to a maximum value among lengths of a plurality of line segments respectively connecting, to each other, two outermost boundary lines of the coil component 1000 opposing each other in the length direction X illustrated in the cross-section image, the plurality of line segments parallel to the length direction X. Alternately, the length of the coil component 1000 may refer to a minimum value among a plurality of line segments respectively connecting, to each other, two outermost boundary lines of the coil component 1000 opposing each other in the length direction X illustrated in the cross-section image, the plurality of line segments parallel to the length direction X. Alternately, the length of the coil component 1000 may refer to an arithmetic mean value of lengths of at least two segments, among a plurality of line segments respectively connecting, to each other, two outermost boundary lines of the coil component 1000 opposing each other in the length direction X illustrated in the cross-section image, the plurality of line segments parallel to the length direction X.

With respect to an optical microscope or SEM image of a cross-section in a length direction X and a thickness direction Z obtained by cutting a central portion of the coil component 1000 in a width direction Y, a thickness of the coil component 1000 may refer to a maximum value among lengths of a plurality of line segments respectively connecting, to each other, two outermost boundary lines of the coil component 1000 opposing each other in the thickness direction Z illustrated in the cross-section image, the plurality of line segments parallel to the thickness direction Z. Alternately, the thickness of the coil component 1000 may refer to a minimum value among a plurality of line segments respectively connecting, to each other, two outermost boundary lines of the coil component 1000 opposing each other in the thickness direction Z illustrated in the cross-section image, the plurality of line segments parallel to the thickness direction Z. Alternately, the thickness of the coil component 1000 may refer to an arithmetic mean value of lengths of at least two segments, among a plurality of line segments respectively connecting, to each other, two outermost boundary lines of the coil component 1000 opposing each other in the thickness direction Z illustrated in the cross-section image, the plurality of line segments parallel to the thickness direction Z.

With respect to an optical microscope or SEM image of a cross-section in a length direction X and a width direction Y obtained by cutting a central portion of the coil component 1000 in a thickness direction Z, a width of the coil component 1000 may refer to a maximum value among lengths of a plurality of line segments respectively connecting, to each other, two outermost boundary lines of the coil component 1000 opposing each other in the width direction Y illustrated in the cross-section image, the plurality of line segments parallel to the width direction Y. Alternately, the width of the coil component 1000 may refer to a minimum value among a plurality of line segments respectively connecting, to each other, two outermost boundary lines of the coil component 1000 opposing each other in the width direction Y illustrated in the cross-section image, the plurality of line segments parallel to the width direction Y. Alternately, the length of the coil component 1000 may refer to an arithmetic mean value of lengths of at least two segments, among a plurality of line segments respectively connecting, to each other, two outermost boundary lines of the coil component 1000 opposing each other in the width direction Y illustrated in the cross-section image, the plurality of line segments parallel to the width direction Y.

Each of the length, width, and thickness of the coil component 1000 may be measured using a micrometer measurement method. According to the micrometer measurement method, each of the length, width, and thickness of the coil component 1000 may be measured by setting a zero point with a gage repeatability and reproducibility (R&R) micrometer, inserting the coil component 1000 according to the present example embodiment into a tip of the micrometer, and turning a measurement lever of the micrometer. When measuring the length of the coil component 1000 using the micrometer measurement method, the length of the coil component 1000 may refer to a value measured once or an arithmetic mean of values measured a plurality of times, which may be applied to the width and thickness of the coil component 1000 in the same manner.

The length, width, and thickness of the coil component 1000 may refer to a length, width, and thickness of the body 100, respectively. However, the present disclosure is not limited thereto, and a length, width, and thickness of the body 100 including an insulating layer formed on the outside thereof, or may refer to a length, width, and thickness of the body 100 including lead frames 400 and 500 formed thereon.

The body 100 may include a magnetic material. The body 100 may be formed by filling a mold with a magnetic material, and may be formed by filling the mold with a composite material including a magnetic material and an insulating resin. A molding process of applying high temperature and high pressure to the magnetic material or the composite material in a mold may be additionally performed, but the present disclosure is not limited thereto.

The magnetic material included in the body 100 may be ferrite particles or metal magnetic particles.

The ferrite particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, and Li-based ferrite powder particles.

The magnetic metal particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal particles may be amorphous or crystalline. For example, the magnetic metal particles may be Fe—Si—B—Cr-based amorphous alloy powder particles, but the present disclosure is not limited thereto.

Each of the ferrite particles and the magnetic metal particles may have an average diameter of about 0.1 μm to about 30 μm, but the present disclosure is not limited thereto.

The body 100 may include two or more types of magnetic materials. Here, different types of magnetic materials mean that the magnetic materials dispersed in the resin are distinguished from each other in terms of one of an average diameter, a composition, crystallinity, and a shape. For example, the body 100 may include two or more magnetic particles having different diameters.

The insulating resin may include epoxy, polyimide, a liquid crystal polymer, or the like alone or in combination, but the present disclosure is not limited thereto.

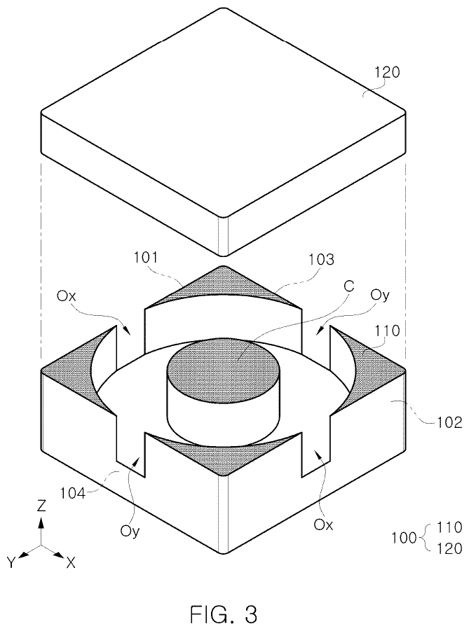

FIG. 3 is a view of a molded portion and a cover portion according to an example embodiment of the present disclosure. Referring to FIG. 3, the body 100 may include a molded portion 110 in which a coil is disposed and a cover portion 120 disposed on the molded portion.

The body 100 of the coil component 1000 according to the present disclosure may respectively change shapes of the molded portion 110 and the cover portion 120 into E-tablet and I-tablet shapes when forming the molded portion 110 and the cover portion 120, thereby effectively adjusting a margin between the coil 300 and side surfaces of the body, and improving a filling rate of a core.

The molded portion 110 may be disposed on a lower portion of the cover portion 120, and include the coil 300 disposed therein. The molded portion 110 may have one surface (upper surface), the other surface (lower surface) opposing the one surface, and a plurality of side surfaces connecting the one surface and the other surface to each other. The plurality of side surfaces of the molded portion 110 may be included in a portion of the plurality of side surfaces of the body 100.

The molded portion 110 may include a core C passing through the coil 300. Here, “passing through the coil 300” may mean that the core passes through an air core of the coil 300 forming at least one turn. The core C may be disposed in an internal region of the coil 300 forming at least one turn, and may have a circular or elliptical cross-section.

An opening Ox, exposing the coil in the first direction (X-direction), may be formed in the molded portion 110. Similarly, an opening Oy, exposing the coil in the second direction (Y-direction), may be formed in the molded portion 110. The openings Ox and Oy may be formed on surfaces of the molded portion 110 included in the side surfaces 101, 102, 103, and 104 of the body 100. Accordingly, when the body 100 is formed by compression, a distance (margin) between the coil 300 and the side surfaces 101, 102, 103, and 104 of the body 100 may be effectively adjusted.

The cover portion 120 may be disposed on an upper surface (one surface) of the molded portion 110 and may cover the coil 300. After being disposed on the molded portion 110 and the coil 300, the cover portion 120 may be pressed and coupled to the molded portion 110. The cover portion 120 may have one surface (lower surface) opposing the molded portion 110, the other surface (upper surface) opposing the one surface, and a plurality of side surfaces connecting the one surface and the other surface. A plurality of side surfaces of the cover portion 120 may be included in a plurality of side surfaces of the body 100 together with a plurality of side surfaces of the molded portion 110.

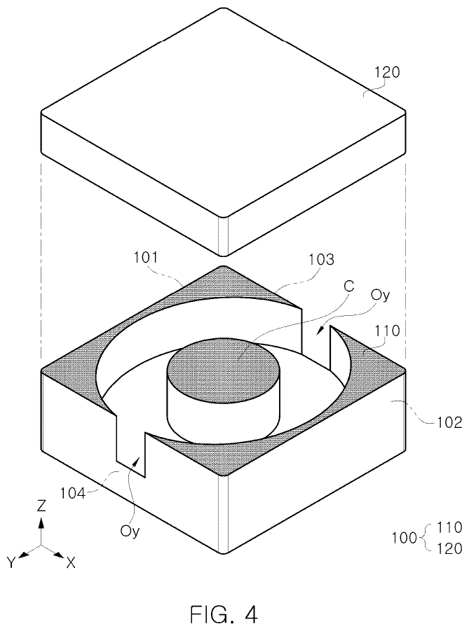

FIG. 4 is a view of a body (a molded portion and a cover portion) of a modification of FIG. 3.

Referring to FIG. 4, an opening Oy, exposing a coil in a second direction (Y-direction), may be formed, and an opening, exposing the coil in a first direction (X-direction), may not be formed.

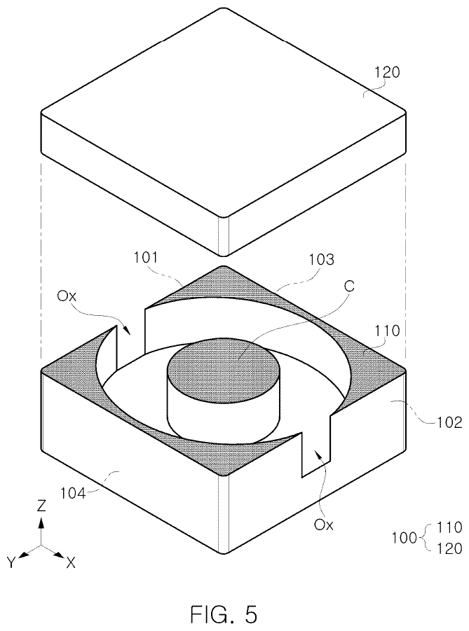

FIG. 5 is a view of a body (a molded portion and a cover portion) of another modification of FIG. 3.

Referring to FIG. 5, a molded portion 110 may have an opening Ox exposing a coil in a first direction (X-direction), and may not have an opening exposing the coil in a second direction (Y-direction).

As described above, an opening O may be formed in the first direction (X-direction) or the second direction (Y-direction), thereby freely designing a margin of the coil 300 in the first direction or the second direction.

The coil 300 may be disposed in a body 100 to exhibit the characteristics of a coil component 1000. For example, when the coil component 1000 according to the present example embodiment is used as a power inductor, the coil 300 may store an electric field as a magnetic field to maintain an output voltage, thereby stabilizing power of an electronic device.

The coil 300 may include a winding portion 310 forming at least one turn around a core C, and lead-out portions 331 and 332 connected to the winding portion and a lead frame to be described below.

Referring to FIGS. 1 and 2, the winding portion 310 may form a plurality of turns from the core 110 toward the outside of the body 100 in the first direction (X-direction) and the second direction (Y-direction) of the body 100. The winding portion 310 may be disposed to be parallel to one surface of the body 105, and a winding axis of the winding portion 310 may be formed to be parallel to a third direction (Z-direction).

The winding portion 310 may be wound in an overall circular or elliptical shape, and a core C may be disposed at the center thereof.

The first and second lead-out portions 331 and 332 may correspond to both ends of the coil 300, and may be connected to lead frames 400 and 500 in the body 100. That is, referring to FIG. 2, a first lead-out portion 331 may be connected to a first lead frame 400, and a second lead-out portion 332 may be connected to a second lead frame 500.

The coil 300 may be an air core coil, may be formed of a metal wire (MW) having a circular cross-section, or may be formed as a flat angle coil, but the present disclosure is not limited thereto.

The coil 300 may be formed by winding a conductive metal, and a remaining portion of the coil 300, excluding a portion in contact with the lead frames 400 and 500 to be described below, may be coated with an insulating coating layer. Specifically, the coil 300 may be formed by spirally winding a metal wire MW, such as a copper wire (Cu-wire), including a metal line and an insulating coating layer covering a surface of the metal line.

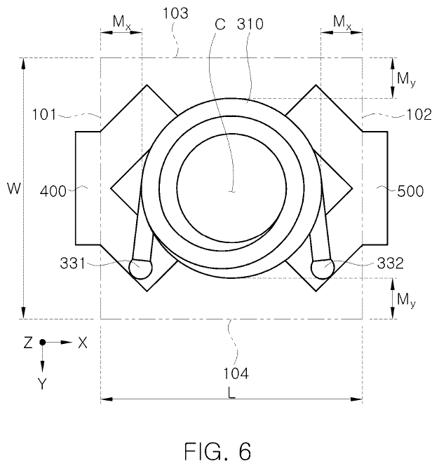

FIG. 6 is a transmission view of a coil component, when viewed in a Z-direction;

A margin structure between a coil and a side surface of a body according to the present example embodiment will be described in detail with reference to FIG. 6.

A coil component 1000 according to the present example embodiment may adjust a shortest distance between a coil 300 and a third side surface 103 or a fourth side surface 104 of a body 100. Specifically, when a shortest distance between the coil 300 and the third side surface 103 of the body is denoted by My and a length of the body in a second direction is denoted by W, My/W may satisfy 0 or more and 0.1 or less.

The shortest distance (My) between the coil 300 and the third side surface 103 of the body may be measured using the following method.

A specimen may be obtained by transmitting through an X-Y plane (L-W plane) of the coil component 1000) using a non-destructive testing (NDT) method, such as X-ray inspection. In the obtained sample, a plurality of line segments respectively connecting, to each other, an outermost boundary line in a second direction (Y-direction) of an external surface of an outermost turn of a winding portion 310 of the coil 300 and a boundary line of the third side surface 103, the plurality of line segments parallel to the second direction (Y-direction), may be obtained. The shortest distance between the coil 300 and the third side surface 103 of the body may refer to a minimum value among lengths of the plurality of line segments, or may refer to an arithmetic mean value of lengths of two or more line segments. Lead-out portions 331 and 332 may be irrelevant to the winding portion 310 forming a turn. Accordingly, when measuring the above-described distance, distances between the lead-out portions 331 and 332 and a side surface of the body may not be considered.

However, the present disclosure is not limited thereto, and the above-described may be checked by obtaining a cross-section of the X-Y plane (L-W plane) of the coil component using a process such as polishing, according to a destructive physical analysis (DPA) method.

A shortest distance between the coil 300 and the fourth side surface 104 of the body 100 may be equal to My. That is, a margin between the coil 300 and the third side surface 103 of the body 100 and a margin between the coil 300 and the fourth side surface 104 of the body 100 may be the same.

Referring to FIG. 6, when a shortest distance between the coil 300 and a first side surface 101 of the body 100 is denoted by Mx, and a length of the body 100 in a first direction is denoted by L, Mx/L may satisfy 0 or more and 0.1 or less.

A shortest distance between the coil 300 and a second side surface 102 of the body 100 may be equal to Mx. That is, a margin between the coil 300 and the first side surface 101 of the body 100 and a margin between the coil 300 and the second side surface 102 of the body 100 may be the same.

The description regarding the shortest distance between the 300 coil and the third side surface 103 of the body may be analogously applied to the shortest distance between the 300 coil and the first side surface 101 of the body.

[Table 1] below shows characteristics (Ls, Rdc, and Isat) of the coil component measured when margins (Mx and My) of the coil component were adjusted, based on Model 1, in which a coil component has a length of 6.0 mm, a width of 6.0 mm, and a thickness of 3.0 mm, and Model 2, in which a coil component has a length of 6.0 mm, a width of 6.0 mm, and a thickness of 4.0 mm.

TABLE 1

| | Margin | Air core | | | | | | | The |
|---|---|---|---|---|---|---|---|---|---|
| | (Mx/My) | diameter | Ls | Rdc | Isat | | Coil_W | Coil_T | number |
| | (μm) | (mm) | (μH) | (mΩ) | (A) | permeability | (mm) | (mm) | of turns |
| Model | 600/600 | 3.28 | 2.21 | 7.94 | 17.64 | Ur30 | 0.47 | 0.43 | 6.5 |
| 1 | 200/200 | 4.08 | 2.5 | 9.25 | 19.25 | | | | |
| | 100/100 | 4.28 | 2.48 | 9.6 | 19.6 | | | | |
| | 0/0 | 4.48 | 2.38 | 9.93 | 20.09 | | | | |
| Model | 600/600 | 2.76 | 2.18 | 5.89 | 17.2 | Ur30 | 0.6 | 0.52 | 6.5 |
| 2 | 200/200 | 3.56 | 2.61 | 6.93 | 21.82 | | | | |
| | 100/100 | 3.76 | 2.62 | 7.19 | 22.75 | | | | |
| | 0/0 | 3.96 | 2.55 | 7.45 | 23.57 | | | | |

Referring to [Table 1], it can be confirmed that Ls has a maximum value when the margin is about 100 μm or 200 μm, compared to a case in which the margin is 600 μm, and that Isat continues to increase as the margin decreases.

That is, when the margin has a length value within a range of 0 or more and 1/10 or less compared to a length and width of the coil component, a size of an air core may be sufficiently secured, and the characteristics of the coil component may be efficiently improved.

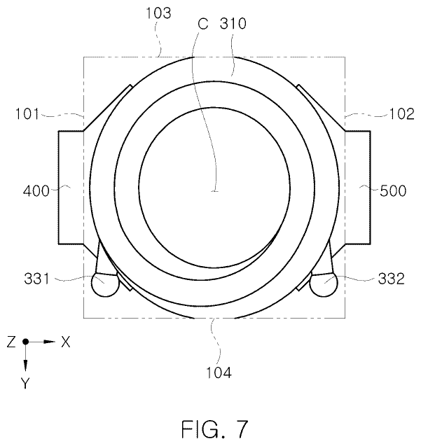

FIG. 7 is a modification of FIG. 6.

Referring to FIG. 7, a winding portion 310 of a coil 300 may extend to a third side surface 103 and a fourth side surface 104 of a body 100. In this case, no margin may be present between the coil 300 and the third side surface 103 and the fourth side surface 104, and thus the ratio (My/W) may be 0.

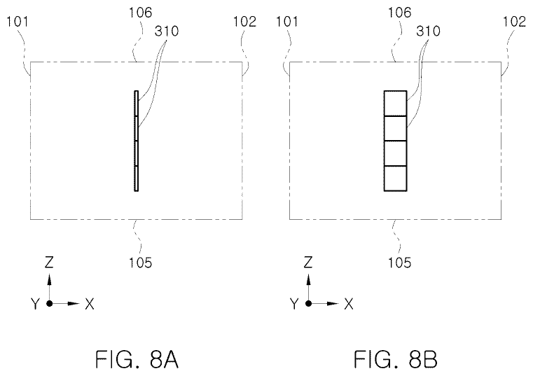

FIG. 8A is a view of FIG. 7, when viewed in a Y-direction. FIG. 8B is a is a view of FIG. 7, when viewed in a Y-direction of modification of FIG. 8A.

Referring to FIGS. 8A and 8B, a winding portion 310 may extend to a surface of a body 100. As illustrated in FIG. 8A, the winding portion 310 may extend to the surface of the body 100 in a straight line. Alternatively, referring to FIG. 8B, the winding portion 310 may extend to the surface of the body 100 in a rectangular shape, such that the winding portion 310 may have a length in a first direction (X-direction). Although not illustrated in the drawings, an insulating film may be additionally formed on the winding portion 310 extending to the surface of the body 100, such that the winding portion 310 may not be exposed to a surface of a component.

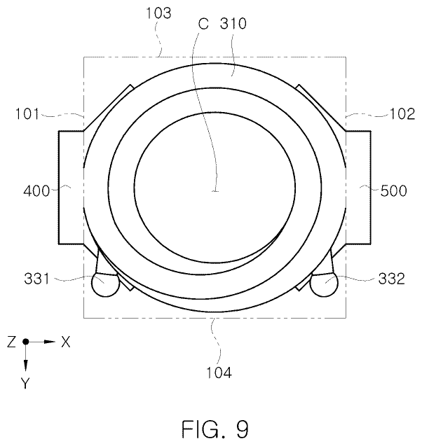

FIG. 9 is another modification of FIG. 6.

Referring to FIG. 9, a winding portion 310 of a coil 300 may extend to a first side surface 101 and a second side surface 102 of a body 100. In this case, no margin may be present between the coil 300 and the first side surface 101 and the second side surface 102, and thus the ratio (Mx/W) may be 0.

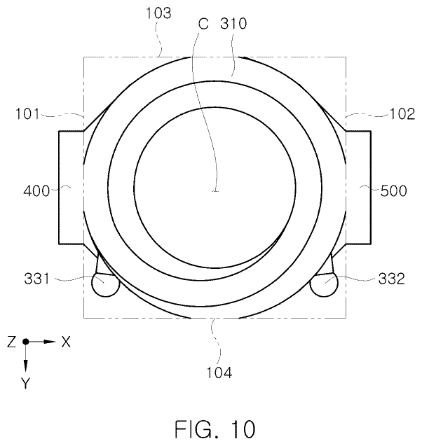

FIG. 10 is another modification of FIG. 6.

Referring to FIG. 10, a winding portion 310 of a coil 300 may extend to a third side surface 103 and a fourth side surface 104 of a body 100. In this case, no margin may be present between the coil 300 and the third side surface 103 and the fourth side surface 104, and thus the ratio (My/W) may be 0.

Simultaneously, the winding portion 310 of the coil 300 may extend to a first side surface 101 and a second side surface 102 of the body 100. In this case, no margin may be present between the coil 300 and the first side surface 101 and the second side surface 102, and thus the ratio (Mx/W) may be 0.

Lead frames 400 and 500 are connected to both ends of the coil 300 in the body 100, and may be disposed on the side surfaces 101 and 102 of the body to serve as external electrodes of a coil component according to the present example embodiment.

Referring to FIG. 2, the lead frames 400 and 500 may include a first lead frame 400 disposed on the first side surface 101 of the body 100, and a second lead frame 500 disposed on the second side surface 102 of the body 100. The first lead frame 400 may be connected to a first lead-out portion 331 in the body 100, and the second lead frame 500 may be connected to a second lead-out portion 332 in the body 100.

The lead frames 400 and 500 may be disposed on the first side surface 101 and the second side surface 102 of the body 100, and may be bent toward one surface 105 of the body.

The lead frames 400 and 500 may include a metal such as Ag, Ag—Pd, Ni, or Cu, and a Ni plating layer and an Sn plating layer may be selectively formed on surfaces of the lead frames.

While example embodiments have been shown and described above, it will be apparent to those skilled in the art that modifications and variations could be made without departing from the scope of the present disclosure as defined by the appended claims.

What is claimed is:

1. A coil component comprising:
a body including a first side surface and a second side surface opposing each other in a first direction, and a third side surface and a fourth side surface opposing each other in a second direction, the body including a magnetic material;
a coil disposed in the body, the coil forming at least one turn; and
a lead frame connected to both ends of the coil in the body, the lead frame disposed on the first side surface and the second side surface of the body,
wherein when a shortest distance between the coil and the third side surface of the body is denoted by My and a length of the body in the second direction is denoted by W, My/W satisfies 0 or more and 0.1 or less.

2. The coil component of claim 1, wherein a shortest distance between the coil and the fourth side surface of the body is My.

3. The coil component of claim 1, wherein when a shortest distance between the coil and the first side surface of the body is denoted by Mx, and a length of the body in the first direction is denoted by L, Mx/L satisfies 0 or more and 0.1 or less.

4. The coil component of claim 3, wherein a shortest distance between the coil and the second side surface of the body is Mx.

5. The coil component of claim 1, wherein the coil extends to the third side surface and the fourth side surface of the body.

6. The coil component of claim 1, wherein the coil extends to the first side surface and the second side surface of the body.

7. The coil component of claim 1, wherein
the body includes a molded portion in which the coil is disposed, and a cover portion disposed on the molded portion, and
the molded portion includes a core passing through the coil.

8. The coil component of claim 7, wherein the molded portion has an opening exposing the coil in the second direction.

9. The coil component of claim 7, wherein the molded portion has an opening exposing the coil in the first direction.

10. The coil component of claim 1, wherein
the body further includes a first surface and a second surface opposing each other in a third direction, and
the lead frame extends to the first surface of the body.

11. A coil component comprising:
a body including a first side surface and a second side surface opposing each other in a first direction, and a third side surface and a fourth side surface opposing each other in a second direction, the body including a magnetic material;
a coil disposed in the body, the coil forming at least one turn; and
a lead frame connected to both ends of the coil in the body, the lead frame disposed on the first side surface and the second side surface of the body,
wherein when a shortest distance between the coil and the first side surface of the body is denoted by Mx and a length of the body in the first direction is denoted by L, Mx/L satisfies 0 or more and 0.1 or less.

12. The coil component of claim 11, wherein a shortest distance between the coil and the second side surface of the body is Mx.

13. The coil component of claim 11, wherein the coil extends to the first side surface and the second side surface of the body.

14. The coil component of claim 11, wherein
the body includes a molded portion in which the coil is disposed, and a cover portion disposed on the molded portion, and
the molded portion includes a core passing through the coil.

15. The coil component of claim 14, wherein the molded portion has an opening exposing the coil in the first direction.

16. The coil component of claim 11, wherein
the body further includes a first surface and a second surface opposing each other in a third direction, and
the lead frame extends to the first surface of the body.

17. The coil component of claim 8, wherein the coil, excluding a portion of the coil in contact with the lead frame, is coated with an insulating coating layer.

18. The coil component of claim 9, wherein the coil, excluding a portion of the coil in contact with the lead frame, is coated with an insulating coating layer.

19. The coil component of claim 15, wherein the coil, excluding a portion of the coil in contact with the lead frame, is coated with an insulating coating layer.

20. The coil component of claim 19, wherein the coil includes a metal winding portion that extends to a surface of the body, wherein the insulating coating layer covers a surface of the metal line.
